(19) United States
(12) Patent Application Publication
(10) Pub. No.: US 2013/0172192 A1
(43) Pub. Date: Jul. 4, 2013

(54) IONICALLY CROSS-LINKED SILICONE COMPOSITION

(71) Applicants: Anubhav Saxena, Bangalore (IN); Alok Sarkar, Malda (IN); M Srividhya, Bangalore (IN)

(72) Inventors: Anubhav Saxena, Bangalore (IN); Alok Sarkar, Malda (IN); M Srividhya, Bangalore (IN)

(73) Assignee: Momentive Performance Materials Inc., Albany, NY (US)

(21) Appl. No.: 13/343,184

(22) Filed: Jan. 4, 2012

(51) Int. Cl. C08G 77/28

(52) U.S. Cl. 504/360

(57) ABSTRACT

An ionically cross-linked silicone elastomeric composition including a polyorganosiloxane of the general formula MₐM^{s}_{b}D_{c}D^{s}_{d}TₑT^{s}_{f}Q and optionally reinforcing or non-reinforcing fillers, and can include wound care agents, personal care ingredients, seed coating agents, agricultural agents, antimicrobial agents and/or antifouling agents.

The present invention relates to elastomeric compositions made from ionic silicones. In particular, ionically cross-linked silicone compositions.

### BACKGROUND OF THE INVENTION

Silicones are a unique class of materials that provide high oxygen permeability, good flexibility, high thermal stability, excellent film formability, non-toxicity, good feel and comfort. Additionally, introducing hydrophilicity to the otherwise hydrophobic siloxanes extends their applications in many different areas. Attaching ionic groups to the siloxane backbone is one way of introducing the hydrophilicity to the siloxanes. Furthermore, the presence of co-operative interactions of the ionic groups in the ionic silicone allows these materials to self-aggregate to form ionic crosslinking and form durable films. Moreover, the ionic groups also can help in retaining different active ingredients (e.g., antibiotics, antifouling, antimicrobial, antifungal, anti-viral agents, fertilizer ingredients, pesticides, anti-aging, moisturizing agents, drugs) into the siloxane matrix and delivering them into a desired site, which gives additional protection from environmental microorganism activities. Therefore, these materials have the potential to improve the film-properties (e.g., strength, controlled delivery of actives, conductivity, water absorptivity, membrane formation, etc.) in many different applications including healthcare, personal care, agriculture, home care, apparel, battery applications as conducting elastomers and coatings. Other interesting features of these films are that they may be rehydrated without any defect, and water soluble active agents may be incorporated to the polymer by swelling the dehydrated material with an aqueous solution of one or more active ingredients. Thus, the ionic silicone-based materials can provide improved film properties while retaining the benefits of control delivery and moisture control.

Japanese Patent Nos. JP 6247827 and JP6247835 disclose the cosmetic composition comprising sulfonate-functionalized silicone and their use in personal care for improving the transfer resistance and feel. The sulfonated polysiloxanes described in the above patents are generally obtained as viscous oil.

U.S. Pat. Nos. 4,525,567 and 4,523,002 describe a method for making sulfonated polysiloxane where zwitterionic sulfonate groups are attached to the siloxane backbone via aliphatic hydrocarbon chains.

WO 2006065467 and corresponding U.S. Pat. No. 7,875,694 disclose a method for making sulfonated polysiloxane where the anionic sulfonate groups are attached to the siloxane backbone via aromatic amide (—ArCONR—) linkage.

EP581296 A2 describes about the solid ionically conductive compositions comprising a crosslinked organosiloxane polymer and a metal sulfonate group bonded with crosslinked silicone polymer or the solids in the polymer for battery application.

U.S. Pat. No. 2,968,643 describes a method of making sulfonated disiloxane and pendant-sulfonated polysiloxanes. These polymers are water soluble and useful as catalysts for the polymerization of isobutylene.

WO 2010/147759A2 describes a thermoplastic elastomeric composition for electronic devices application containing silicone ionomers with carboxylic groups. The disposing of the thermoplastic elastomer on the electronic device is done by heating above the flow temperature of the thermoplastic elastomer.

U.S. Pat. No. 7,759,434 describes the formation of crosslinked elastomers through the covalent bonding and/or the organometallic or ionic crosslinking.

There exists demand in the marketplace for improved ionically cross-linked silicone elastomeric compositions. Accordingly, the present invention provides improved ionically cross-linked silicone elastomeric compositions that meet this demand which are described in detail in the sections directly following.

### SUMMARY OF THE INVENTION

Provided herein is an ionically cross-linked silicone elastomeric composition comprising:

a polyorganosiloxane of the general formula

MₐM^{s}_{b}D_{c}D^{s}_{d}TₑT^{s}_{f}Q

wherein:

Mₐ=R¹R²R³SiO_{1/2}

M^{s}_{b}=R⁴R⁵R^{s}SiO_{1/2}

D_{c}=R⁶R⁷SiO_{2/2}

D^{s}_{d}=R⁸R^{s}SiO_{2/2}

Tₑ=R⁹SiO_{3/2}

T^{s}_{f}=R^{s}SiO_{3/2}

Q=SiO_{4/2}

and

R¹, R², R⁴, R⁵, R⁷, R⁸, are independently selected from aliphatic, aromatic or fluoro containing monovalent radicals comprising hydrocarbons in the range of 1-60 carbon atoms, R³, R⁶, R⁹ can be independently chosen from glycolide {—C(O)CH₂O—}, lactide {—C(O)CH(CH₃)O—}, butyrolactide {—C(O)CH₂CH₂CH₂O—} and caprolactide {—C(O)CH₂CH₂CH₂CH₂CH₂O—} radicals or hydrocarbon radical defined by R¹. R^{s} is (i) a monovalent radical bearing ion-pairs and having the formula -A—I^{x-}Mₙ^{y+} wherein A is a spacing group having at least 1 spacing atoms selected from a divalent hydrocarbon or hydrocarbonoxy group, I is an ionic group such as sulfonate —SO₃⁻, sulfate —OSO₃²⁻, carboxylate —COO⁻, phosphonate —PO₃²⁻ and —OPO₃³⁻ phosphate group, M is hydrogen or a cation independently selected from alkali metals, metal complexes, alkaline earth metals, transition metals and organic cations, quaternary ammonium and phosphonium groups, hydrocarbon cations, alkyl cations, and cationic biopolymers; n and y are integers independently of from 1 to 6, and x is an integer which is the product of n times y, or (ii) zwitterions having the formula —R′—NR″₂⁺—R′″-I⁻ where I is an ionic group such as a sulfonate —SO₃⁻, sulfate, —OSO₃²⁻, carboxylate —COO⁻, phosphonate —PO₃²⁻ and phosphate —OPO₃³⁻ group wherein R′ is a divalent hydrocarbon radical from 1 to 20 carbon atoms, R″ is a monovalent hydrocarbon radical from 2 to 20 carbon atoms, and R′″ is a divalent hydrocarbon radical containing from about 2 to about 20 carbon atoms.

Optionally, the composition can include areinforcing or non-reinforcing filler and/or various agents useful in healthcare, personal care, agriculture, antifouling coatings, construction, automotive vehicles, electronics/electrical applications, aerospace, fuel cells, production of domestic appliances, machine and instrument construction, coatings, oil and gas, membranes and adhesives.

The present invention is further described in the detailed description section provided below.

### BRIEF DESCRIPTION OF THE DRAWING(S)

Various embodiments of the invention are discussed below with respect to the drawings wherein:

FIG. 1 is a graph showing the cumulative release of silver from films comprising the ionic silicone of the invention.

### DETAILED DESCRIPTION OF THE INVENTION

The present invention relates to the elastomeric compositions that are made from ionic silicones through the ionic aggregates, which provide the control release of actives along with improved flexibility and water absorbing benefits. The silicone elastomers of the present invention particularly are characterized by the assembly of the ionic groups at ion rich domains of specific dimensions of 40-200 nm which act as the ionic filler to the silicone elastomer. These ionic assemblies are completely neutralized by the suitable counter ions to stabilize the charge. The ion rich domains help in the formation of transparent to translucent silicone elastomers that show improved water absorption, and are capable of controlled delivery of the active ingredients in different applications with a great control on the reproducibility. High oxygen permeability, comfort, improved flexibility are governed by the hydrophobic siloxane domains whereas the high water absorbing property and slow and sustained release of active ingredients are governed by the ionic aggregates. These properties are important in many different applications including, healthcare, personal care, agriculture, antifouling coatings, construction, automotive vehicles, electronics/electrical applications, aerospace, fuel cells, production of domestic appliances, machine and instrument construction, coatings, oil and gas, membranes and adhesives.

In the specification and claims herein, the following terms and expressions are to be understood as indicated.

As used in the specification and including the appended claims, the singular forms “a,” “an,” and “the” include the plural, and reference to a particular numerical value includes at least that particular value, unless the context clearly dictates otherwise.

Ranges expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

Other than in the working examples or where otherwise indicated, all numbers expressing amounts of materials, reaction conditions, time durations, quantified properties of materials, and so forth, stated in the specification and claims are to be understood as being modified in all instances by the term “about.”

It will be understood that any numerical range recited herein includes all sub-ranges within that range and any combination of the various endpoints of such ranges or sub-ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The expression “aliphatic hydrocarbon” means any hydrocarbon group from which one or more hydrogen atoms has been removed and is inclusive of alkyl, alkenyl, alkynyl, cyclic alkyl, cyclic alkenyl, cyclic alkynyl, aryl, aralkyl and arenyl and may contain heteroatoms.

The term “alkyl” means any monovalent, saturated straight, branched or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

The expressions “cyclic alkyl”, “cyclic alkenyl”, and “cyclic alkynyl” include bicyclic, tricyclic and higher cyclic structures as well as the aforementioned cyclic structures further substituted with alkyl, alkenyl, and/or alkynyl groups. Representative examples include norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “arenyl” means any aryl group (as defined herein) in which one or more hydrogen atoms have been substituted by the same number of like and/or different alkyl groups (as defined herein). Examples of aryls include phenyl and naphthalenyl. Examples of aralkyls include benzyl and phenethyl. Examples of arenyls include tolyl and xylyl.

It will be understood herein that all measures of viscosity are obtained at 25 degrees Celsius unless noted otherwise.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Provided herein is an ionically cross-linked silicone elastomeric composition comprising:

a polyorganosiloxane of the general formula

MₐM^{s}_{b}D_{c}D^{s}_{d}TₑT^{s}_{f}Q

wherein:

Mₐ=R¹R²R³SiO_{1/2}

M^{s}_{b}=R⁴R⁵R^{s}SiO_{1/2}

D_{c}=R⁶R⁷SiO_{2/2}

D^{s}_{d}=R⁸R^{s}SiO_{2/2}

Tₑ=R⁹SiO_{3/2}

T^{s}_{f}=R^{s}SiO_{3/2}

Q=SiO_{4/2}

and

R¹, R², R⁴, R⁵, R⁷, R⁸, are independently selected from aliphatic, aromatic or fluoro containing monovalent radicals comprising hydrocarbons in the range of 1-60 carbon atoms. This can also be branched, linear or cyclic, saturated or unsaturated monovalent alkyl groups having from 1 to 36 carbon atoms.

R³, R⁶, R⁹ are independently selected from —CH₂CH(R¹¹)(CₙH₂ₙ)—O—(C₂H₄O)ₒ—(C₃H₆O)ₚ—(C₄H₈O)_{q}—R¹¹, wherein subscript n is zero or positive and has a value in the range of 0 to 6, subscripts o, p and q are zero or positive and independently selected from a value in the range of 0 to 100, subject to the limitation of o+p+q greater than or equal to 1. R¹¹ can be hydrogen or an aliphatic, aromatic or fluoro hydrocarbon having from 1 to 60 carbon atoms, or R¹¹ can be independently chosen from glycolide {—C(O)CH₂O—}, lactide {—C(O)CH(CH₃)O—}, butyrolactide {—C(O)CH₂CH₂CH₂O—} and caprolactide {—C(O)CH₂CH₂CH₂CH₂CH₂O—} radicals or hydrocarbon radical defined by R¹ or R¹¹ can be independently chosen from acyl, epoxy and amine radicals.

R^{s} is a monovalent radical bearing ion-pairs and having the formula -A—I^{x-}Mₙ^{Y+}; or zwitterions having the formula —R′—NR″₂⁺—R′″-I⁻, where I is an ionic group such as sulfonate —SO₃⁻, sulfate —OSO₃²⁻, carboxylate —COO⁻, phosphonate —PO₃²⁻ and phosphate, OPO₃³⁻ group,

“A” is a spacing group having at least 1 spacing atoms selected from a divalent hydrocarbon or hydrocarbonoxy group.

In one other embodiment wherein A is a divalent hydrocarbon is an aryl group selected from —(CH₂)_{g}C₆H₄—, —CH₂CH(CH₃)(CH₂)_{g}C₆H₄—, and —(CH₂)ₕC₆H₄(CH₂)_{g}— where h has a value of 1 to about 20 and g has a value of 0 to about 10.

In another embodiment of the invention, “A” is a hydrocarbon group is alkyne group selected from —(CHR¹⁰)ᵢ— where i has a value of 1 to 20 and R¹⁰ is hydrogen or R¹

In another embodiment wherein A″ is a hydrocarbonoxy group selected from, —CH(R¹⁰)ᵢ—O[CH(R¹⁰)(CH₂—O)]₁—(CH₂)ᵢ where R¹⁰ is hydrogen or R¹ and i has a value of 1 to 20. specifically from 1 to about_{—}10, j has a value of 0 to 50 and i′ has the value from 0 to 50.

“I” is an ionic group such as sulfonate —SO₃⁻, sulfate —OSO₃²⁻, carboxylate —COO⁻, phosphonate —PO₃²⁻ or phosphate —OPO₃³⁻ groups.

“M” is hydrogen or a cation independently selected from alkali metals, alkali earth metals, transition metals, metals, metal complexes, organic cations like quaternary ammonium and phosphonium groups, hydrocarbon cations, alkyl cations, cationic biopolymers.

Alternatively, each cation is independently selected from Li, Na, K, Cs, Mg, Ca, Ba, Zn, Cu, Ni, Fe, Ga, Al, Mn, Cr, Ag, Au, Pt, Pd, Pb, Sb, Ru, Sn and Rh. Also, x is defined as the product of n times y. One skilled in the art can understand that the cations are not limited to the above said, and also can exist in multivalent forms, e.g., Mn⁺² and Mn⁺³

R′ is a divalent hydrocarbon radical from 1 to about 20 carbon atoms and R″ is divalent hydrocarbon radical from 1 to about 20 carbon atoms. R′″ is divalent hydrocarbon radical containing from 2 to about 20 carbon atoms.

Optionally, the composition can comprise a reinforcing or non-reinforcing filler such as a finely divided surface treated/untreated metal oxides (e.g., silica, titania, zirconia, ceria, etc), clay, boron nitride, inorganic fillers such as calcium carbonate, polysaccharides, carbon black, silicone resins, natural and synthetic fibers etc. In an embodiment the composition can include 0.0 to 99.0 weight % of filler, preferably 0.0 to 5.0 weight % of filler.

The silicone elastomers produced according to the invention are suitable for many applications in which the known advantageous properties of the silicones and the properties that could be derived from the ionic clusters are important, preferably in the fields of healthcare, personal care, agriculture, automobile, electronics/electrical, aerospace, fuel cells, production of domestic appliances, machine and instrument construction, coatings, membranes and adhesives.

Silicones have extensively been used in healthcare applications because of their unique film forming ability, which can provide high oxygen permeability, superior smoothness and greater comfort to the wearer. However, due the lack of the hydrophilicity and water-absorbing property of the silicones, their applications in wound care are very limited (e.g. as backing layer for low exuding wound and scar management). In the wound care industry, there is a growing interest in the development of wound dressings that possess functionality beyond providing physical protection and an optimal moisture environment for the wound. To this end, a dressing material based on a sulfonated tri-block polymer has been reported. This sulfonated polymer possesses an ion-exchange capability that is amenable to binding and controlled release of a variety of therapeutic agents and offers several advantages over existing commercial hydrogels used as wound dressings. These include: (1) excellent film forming properties, (2) hydrophilicity that is proportional to sulfonation level, (3) easy preparation of fabric supported dressings (e.g., polyester, cotton, nylon), (4) excellent mechanical integrity of the materials when hydrated, and (5) stability to a variety of sterilization methodologies. However, synthetic polymers comprised of organic moieties often lack the degree of flexibility or plasticity that is desired for application to a skin surface that it is in constant movement. Ionic silicone-based film forming polymers deliver the unique benefits of silicones such as high oxygen permeability and comfort along with high moisture transmission, controlled release of active agents, e.g., silver, antibiotics, growth factors, peptides, proteins and polysaccharides like heparin for the wound care applications.

In addition, the ionic silicone-based film forming polymers can also be used for drug delivery applications. Silicones have a long tradition of being used for drug delivery through a wide variety of routes of administration such as transdermal (silicone gels and adhesive films for delivery of anti-inflammatories, analgesics, steroids, hormones and as smoking-cessation devices), mucosal (elastomer rings and plugs for vaginal delivery of contraceptives, anti-viral agents, anti-fungal agents). However, only relatively hydrophobic drugs can be delivered through the silicone matrix. Hydrophilic active agents have been found to slowly crystallize, which reduces their activity and alters the delivery profile of the device. The film-forming ionic silicones of the present invention, on account of their hydrophilicity can prevent this unwanted crystallization of the drug. Additionally, many drugs can be loaded as bound to the ionic moieties within the silicones, which may further reduce their potential to crystallize and de-activate, thereby increasing shelf-life. Examples of pharmaceutically active ingredients that can be included within the composition include but are not limited to bioactives, anti-acne agents, anti-ageing agents, anti-caries agents, anti-fungal agents, anti-microbial agents, anti-oxidants, anti-cancer, anti-viral, anti-inflammatory, anti-coagulants, hemostatic agents, exfoliants, hormones, hormone analogs, enzymes, proteins and peptides, medicinal compounds, biocides, external analgesics, oral care agents, oral care drugs, oxidizing agents, reducing agents, skin protectants, essential oils, insect repellents, UV light absorbing agents, solar filters, pigments, hydrating agents, vitamins and their combinations thereof.

The composition comprising the above ingredients can be utilized for numerous healthcare applications comprising of drug delivery systems, transdermal patches, wound healing patches, wound dressing patches, transdermal iontophoresis, scaffold for tissue engineering, anti-microbial devices, wound management devices, ophthalmic devices, bioinserts, prostheses and body implants.

It has been established that in control release fertilizer applications, the coatings of ionically and covalently cross-linked polymers act as barrier to water-soluble constituents of the fertilizers, shielding them from premature release in aqueous environments for a long period of time. The benefits obtained by the use of these coatings can include labor savings, increased crop yield, increased nitrogen utilization efficiently and time savings. In this regard, a coating material based on the ionically and covalently cross-linked sulfonated polystyrene and inter-polymer complexes have been reported which can provide sustained release of water soluble constituents of fertilizers through a period ranging from several days to many months. However, the organic sulfonated polymers such as sulfonated polystyrene are highly brittle in nature and the film comprising such polymers can often develop cracks that may result in undesired leaching of the fertilizer constituents. The ionic polysiloxanes of the invention are excellent alternatives as these materials can form highly flexible elastomeric films that are devoid of any defects or cracks. Examples of fertilizers and agricultural materials that can be incorporated within ionic silicone films include but are not limited to: urea, urea ammonium nitrogen, zinc sulfate, ferrous sulfate, ammonium thiosulfate, potassium sulfate, monoammonium phosphate, urea phosphate, calcium nitrate, phosphoric acid, magnesium hydroxide, manganese carbonate, calcium polysulfide, manganese sulfate, calcium chloride, diammonium phosphate, disodium phosphate, monoammonium phosphate, monopotassium phosphate, sodium hexametaphosphate, sodium tripolyphosphate, tetrapotassium pyrophosphate, trisodium phosphate, tetrasodium pyrophosphate, oxides/sulfates of Zn, Mn, Fe, Cu, Mg, boron, boric acid, potassium and sodium salts of boric acid, and sodium molybdate.

Seed coatings, which usually contain a pesticide, fungicide or other active ingredients and film-forming polymer to hold the active ingredients on the seed, are commonly applied to the surface of the seeds to protect them from various microbial and insecticidal activities. The desirable properties of the polymers used in the seed coatings are that they: (a) adhere effectively to the seed surface while providing the uniform coatings, (b) result in a flexible and non-tacky coating with high degree of tear and abrasion resistance, (c) render the coating permeable to moisture, oxygen, visible light, carbon dioxide, and (d) allow the films to retain and release various active ingredients over a prolonged period. Various prior cross-linked organic polymers used as a film former in the prior art for seed coating applications mainly include the cross-linked copolymer of acrylics, modified polyacrylamide and vinyl acrylic resins or the copolymers of polyvinyl acetate, methyl cellulose, etc. However, most of these coatings suffer from the following drawbacks: (a) they are not permeable to gases, (b) they have poor ability to control rate of release of ingredients, and (c) at low temperature (especially in winter season) the coating has a tendency to form discontinuous films which exhibit cracking and flaking. Seed coatings comprising cross-linkable silicones address many of the problems associated with traditional organic coatings. However, due to the strongly hydrophobic nature of the silicone polymers, the active ingredients, which are mostly hydrophilic in nature, are not compatible with the films and hence can easily get separated out from the films. However, the ionically cross-linked silicone composition provided herein can deliver the unique film forming benefits of silicones along with the sustained release of actives. The ionic silicone is a novel class of material, which exhibits the unique benefits of silicones with a controllable extent of hydrophilicity and can be used in seed coating applications. Thus, examples of some agents that can be incorporated in seed coatings include pesticides. The term pesticide means any compound used to destroy pests, e.g., rodenticides, insecticides, miticides, fungicides, and herbicides. Illustrative examples of pesticides that can be employed include, but are not limited to, growth regulators, photosynthesis inhibitors, pigment inhibitors, mitotic disrupters, lipid biosynthesis inhibitors, cell wall inhibitors, and cell membrane disrupters. The amount of pesticide employed in compositions of the invention varies with the type of pesticide employed. More specific examples of pesticide compounds that can be used with the compositions of the invention are, but not limited to, herbicides and growth regulators, such as: phenoxy acetic acids, phenoxy propionic acids, phenoxy butyric acids, benzoic acids, triazines and s-triazines, substituted ureas, uracils, bentazon, desmedipham, methazole, phenmedipham, pyridate, amitrole, clomazone, fluridone, norflurazone, dinitroanilines, isopropalin, oryzalin, pendimethalin, prodiamine, trifluralin, glyphosate, sulfonylureas, imidazolinones, clethodim, diclofop-methyl, fenoxaprop-ethyl, fluazifop-p-butyl, haloxyfop-methyl, quizalofop, sethoxydim, dichlobenil, isoxaben, and bipyridylium compounds. Fungicide compositions that can be used with the present invention include, but are not limited to, aldimorph, tridemorph, dodemorph, dimethomorph; flusilazol, azaconazole, cyproconazole, epoxiconazole, furconazole, propiconazole, tebuconazole and the like, imazalil, thiophanate, benomyl carbendazim, chlorothialonil, dicloran, trifloxystrobin, fluoxystrobin, dimoxystrobin, azoxystrobin, furcaranil, prochloraz, flusulfamide, famoxadone, captan, maneb, mancozeb, dodicin, dodine, and metalaxyl. Insecticide, larvacide, miticide and ovacide compounds that can be used with the composition of the present invention include, but are not limited to, Bacillus thuringiensis, spinosad, abamectin, doramectin, lepimectin, pyrethrins, carbaryl, primicarb, aldicarb, methomyl, amitraz, boric acid, chlordimeform, novaluron, bistrifluoron, triflumuron, diflubenzuron, imidacloprid, diazinon, acephate, endosulfan, kelevan, dimethoate, azinphos-ethyl, azinphos-methyl, izoxathion, chlorpyrifos, clofentezine, lambda-cyhalothrin, permethrin, bifenthrin, cypermethrin and the like.

The polymer functionalized with anionic groups such as sulfonate, sulfate, carboxylate or phosphate groups can ionically bind basic nitrogen-containing biocides and these polymer-biocide bonds are almost irreversible and very stable in non-polar solvents. In water, however the interaction is weaker and exhibits a larger degree of reversibility. Therefore, when these polymer films are exposed to water, the biocide molecules in the surface layer dissociate and desorbs from the polymer. This unique combination of properties, make these materials highly attractive for antifouling paint applications where slow and sustained release of the biocide ingredients is an essential requirement. Recently, organic polymers functionalized with different anionic groups have been used in antifouling paint applications which show improved performance with respect to the distribution and fixation of the biocide in the paint matrix. Silicone-based paints on the other hand offer some benefits including resistance to heat and weathering, water repellency, superior smoothness etc., which are not available from the organic polymers-based paints. However, use of the ionically cross-linked silicone composition of the invention achieves superior distribution and fixation of the biocides in the paint while retaining the benefits of silicone. Examples of antifouling agents that can be incorporated within the composition include, but are not limited to: metal ions such as copper, silver, zinc, tin, organotin compounds, cationic agents such as chlorhexidine, poly(hexamethylene biguanide), Tralopyril, zinc pyrithione, copper thiocyanate, copper(I)oxide, Dichlofluanid, copper pyrithione, 4,5-dichloro-2-octyl-2H-isothiazole-3-on, benzalkonium chloride, or Zineb.

The ionically cross-linked elastomer composition of the present invention can also be utilized in personal care for providing transfer resistance, moisturization and control delivery of various personal care ingredients.

The ionic groups of the present inventions are hydrophilic in nature. Moreover due the strong aggregation behavior of the ionic groups these compositions were observed to form transfer resistant films. Because of this unique combination of properties, these compositions can provide the flexibility to develop personal care formulations along that has the advantages of high transfer resistance, gloss, comfort, and control delivery of actives.

The personal care formulations comprising of the present composition can contain surfactants, emulsifiers, solvents, emollients, moisturizers, humectants, pigments, colorants, fragrances, biocides, preservatives, chelating agents, antioxidants, anti-microbial agents, anti-fungal agents, antiperspirant agents, exfoliants, hormones, hormone analogs, enzymes, proteins and peptides, medicinal compounds, vitamins, alpha-hydroxy acids, beta-hydroxy acids, retinols, niacinamide, skin lightening agents, salts, electrolytes, alcohols, polyols, absorbing agents for ultraviolet radiation, botanical extracts, organic oils, waxes, thickening agents, particulate fillers, silicones, clays, plasticizers, occlusives, sensory enhancers, esters, resins, film formers, film forming emulsifiers, high refractive index materials and their combinations thereof.

Further, the personal care compositions comprising of the present invention can find application as antiperspirant/deodorants, including sprays, sticks and roll-on products, shaving products, skin lotions, moisturizers, toners, bath products, cleansing products, shampoos, conditioners, combined shampoo/conditioners, mousses, styling gels, hair sprays, hair dyes, hair color products, hair bleaches, waving products, hair straighteners, nail polish, nail polish remover, nail creams and lotions, cuticle softeners, sunscreen, insect repellent, anti-aging products, lipsticks, foundations, face powders, eye liners, eye shadows, blushes, makeup, mascaras, moisturizing preparations, foundations, body and hand preparations, skin care preparations, face and neck preparations, tonics, dressings, hair grooming aids, aerosol fixatives, fragrance preparations, aftershaves, make-up preparations, soft focus applications, night and day skin care preparations, non-coloring hair preparations, tanning preparations, synthetic and non-synthetic soap bars, hand liquids, nose strips, non-woven applications for personal care, baby lotions, baby baths and shampoos, baby conditioners, shaving preparations, cucumber slices, skin pads, make-up removers, facial cleansing products, cold creams, sunscreen products, mousses, spritzes, paste masks and muds, face masks, colognes and toilet waters, hair cuticle coats, shower gels, face and body washes, personal care rinse-off products, gels, foam baths, scrubbing cleansers, astringents, nail conditioners, eye shadow sticks, powders for face or eye, lip balms, lip glosses, hair care pump sprays and other non-aerosol sprays, hair-frizz-control gels, hair leave-in conditioners, hair pomades, hair de-tangling products, hair fixatives, hair bleach products, skin lotions, pre-shaves and pre-electric shaves, anhydrous creams and lotions, oil/water, water/oil, multiple and macro and micro emulsions, water-resistant creams and lotions, anti-acne preparations, mouth-washes, massage oils, toothpastes, clear gels and sticks, ointment bases, topical wound-healing products, aerosol talcs, barrier sprays, vitamin and anti-aging preparations, herbal-extract preparations, bath salts, bath and body milks, hair styling aids, hair-, eye-, nail- and skin-soft solid applications, controlled-release personal care products, hair conditioning mists, skin care moisturizing mists, skin wipes, pore skin wipes, pore cleaners, blemish reducers, skin exfoliators, skin desquamation enhancers, skin towelettes and cloths, depilatory preparations, personal care lubricants, nail coloring preparations, sunscreens, cosmetics, hair care products, skin care products, toothpastes, drug delivery systems for topical application of medicinal compositions that are to be applied to the skin and combinations comprises at least one of the foregoing applications.

The ionically crosslinked elastomer is formed by the co-operative interactions of the ionic groups in the ionic silicones that allows them to self-aggregate to form ionic crosslinking and thereby the durable elastomer.

The detailed experimental procedure for the ionic silicone material synthesis and the ionically crosslinked elastomer is given in the examples.

### Example 1

A three necked 500 mL flask was charged with 70.08 g (60.0 mmol) alpha-methylstyrene and 10.0×10⁻⁴ g platinum catalyst. The temperature of the resulting mixture was brought to 115 degree Celsius, then 30.0 g (120.5 mmol) 1,3,5,7-tetramethylcyclotetrasiloxane was added drop wise and continued to stir. The progress of the reaction mixture was monitored by ¹H NMR. After 12 hrs. of the reaction, complete conversion of silicone hydride was indicated by the NMR. Then, the reaction mixture was vacuum stripped at 150° C. for 2 hrs. to remove unreacted alpha-methylstyrene, which gave 80.5 g aralkylene substituted cyclotetrasiloxane. (Yield: (95%)_{.}

To 14.24 g (20.0 mmol) of the above aryl substituted cyclotetrasiloxane, 18.64 g (160.0 mmol) chlorosulfonic acid dissolved in 4.0 mL dichloromethane was added dropwise through a period of 30 minutes while the mixture was agitated by stirring at room temperature. The resulting mixture was continued to stir for additional 30 minutes. The completion of the reaction was determined by ¹H NMR where complete sulfonation of the aromatic ring was indicated by the disappearance of para-substituted aromatic proton peak. The resulting mixture was then vacuum stripped to remove dichloromethane and other volatile such as chlorosulfonic acid and hydrochloric acid.

### Example 2

To 23.56 g (220 mmol) of the sulfonated cyclotetrasiloxane obtained from Example 1, 112.7 g (380.0 mmol) octamethyltetracyclosiloxane and 1.036 g (6.4 mmol) hexamethyldisiloxane were added and continued to stir at room temperature. After 6 hrs. of reaction, an equilibration of ˜82% was indicated by solid content analysis. At this point, 32 g (320 mmol) sodium bicarbonate were added to the mixture and agitated by stirring for 3 hrs. The complete neutralization of the sulfonic acid was determined by indication of pH 7 using pH paper, and the reaction mixture was filtered. The filtrate was vacuum stripped at 30 mmHg/70 degree Celsius ° C., and the sulfonated polysiloxane was obtained as a white solid (120.0 g). The structure of the product obtained was confirmed by ²⁹Si and proton NMR. Yield: 84%.

### Example 3

To 11.78 g (110 mmol) the sulfonated cyclotetrasiloxane obtained from Example 1, 56.3 g (190.0 mmol) octamethyltetracyclosiloxane and 0.324 g (2.0 mmol) hexamethyldisiloxane were added and agitated by stirring at room temperature. After 6 hrs. of reaction, an equilibration of ˜82% was indicated by solid content analysis. At this point, 16 g (160 mmol) sodium bicarbonate were added to the mixture with continued stirring for 3 hrs. The complete neutralization of the sulfonic acid was determined by the indication of pH 7 using pH paper, and the reaction mixture was filtered. The filtrate was vacuum stripped at 30 mmHg/70 degree Celsius, and the sulfonated polysiloxane was obtained as a white solid (71.0 g). Yield: 85%. The structure of the product obtained was confirmed by ²⁹Si and proton NMR

### Example 4

To 23.56 g (220 mmol) of the sulfonated cyclotetrasiloxane obtained in Example 1, 112.7 g (380.0 mmol) octamethyltetracyclosiloxane and 0.324 g (2.0 mmol) hexamethyldisiloxane were added with continued stirring at room temperature. After 6 hrs. of reaction, an equilibration of ˜82% was indicated by ²⁹Si NMR. At this point, 32 g (320 mmol) sodium bicarbonate were added to the mixture with continued stirring for 3 hrs. The complete neutralization of the sulfonic acid was determined by the indication of pH 7 using pH paper, and the reaction mixture was filtered and the filtrate was vacuum stripped at 30 mmHg/70 degree Celsius, whereupon the sulfonated polysiloxane was obtained as a white rubbery solid (120.0 g). The structure of the product obtained was confirmed by ²⁹Si and proton NMR. Yield: 85%.

### Example 5

To 23.56 g (220 mmol) of the sulfonated cyclotetrasiloxane obtained in Example 1, 231.34 g (780.0 mmol) octamethyltetracyclosiloxane and 0.648 g (4.0 mmol) hexamethyldisiloxane were added with continued stirring at room temperature. After 6 hrs. of reaction, an equilibration of ˜82% was indicated by ²⁹Si NMR. At this point, 32 g (320 mmol) sodium bicarbonate were added to the mixture with continued stirring for 3 hrs. The complete neutralization of the sulfonic acid was determined by indication of pH 7 using pH paper, and the reaction mixture was filtered. The filtrate was vacuum stripped at 30 mmHg/70 degree Celsius, and the sulfonated polysiloxane was obtained as a white rubbery solid (193.0 g). Yield: 75%. The structure of the product obtained was confirmed by ²⁹Si and proton NMR.

### Example 6

To 23.56 g (220 mmol) of the sulfonated cyclotetrasiloxane obtained in Example 1, 112.7 g (380.0 mmol) octamethyltetracyclosiloxane and 0.162 g (1.0 mmol) hexamethyldisiloxane were added with continued stirring at room temperature. After 6 hrs. of reaction, an equilibration of ˜82% was indicated by ²⁹Si NMR. At this point, 32 g (320 mmol) sodium bicarbonate were added to the mixture with continued stirring for 3 hrs. The complete neutralization of the sulfonic acid was determined by indication of pH 7 using pH paper, and the reaction mixture was filtered. The filtrate was vacuum stripped at 30 mmHg/70 degree Celsius, when the sulfonated polysiloxane was obtained as a white waxy solid (117.0 g) Yield: 83%. The structure of the product obtained was confirmed by ²⁹Si and proton NMR.

### Example 7

Film forming composition with sulfonated silicones

Elastomeric films were obtained by dissolving the synthetic samples in solvents like isopropanol (IPA), IPA/water mixture, methyl ethyl ketone (MEK), ethyl acetate and other low boiling solvents by a solvent casting method.

Procedure

The sulfonated silicone samples were immersed in water and when they started swelling isopropanol was added and kept for 30 min. These were agitated in a speed mixer to get viscous solutions, which were then applied as films on selected substrates and allowed to dry at ambient temperature and dried in the oven at 100-150° C. A colorless transparent elastomeric film of the sodium salt of the sulfonated silicone was peeled off from the substrate. The selected substrates included polytetrafluoroethylene (PTFE), glass, polyethylene, polypropylene, and polycarbonate. The Youngs Modulus, tensile strength, % elongation, contact angle, % water absorption and Share A hardness of Examples 7a, 7b, 9, 10, 11, 12 and 13b as measured by conventional techniques are set forth in tabulated form in Table 1 below.

### Example 7a

5 g of the product of Example 4 were dissolved in a solvent mixture of 2.5 mL water and 2.5 mL IPA to get a colorless viscous solution. This was poured into a PTFE mold on an even surface and allowed to dry at ambient temperature for 12 hrs. This was further dried in the oven at 120° C. to get a transparent colorless film. The transparency of the film was measured to be 82%.

### Example 7b

5 g of the product of Example 6 were dissolved in a solvent mixture of 2.5 mL water and 2.5 mL IPA to get a colorless viscous solution. This was poured into a PTFE mold on an even surface and allowed to dry at ambient temperature for 12 hrs. This was further dried in the oven at 120° C. to get a transparent colorless film. The transparency of the film was measured to be 80%.

### Example 8

### Loading of Silica Nanoparticles

### Example 8a

The product of Example 4 was loaded with 5 wt % nanosilica by insitu mixing as described above and cast as film by following the procedure in Example 7 and thereafter allowed to dry. The transparency of the film was measured to be 76%. The Shore A hardness was 50 and the percent water absorption for ½ hr soaking was found to be 43 wt %.

### Example 8b

The product of Example 6 was loaded with 25 wt % nanosilica by insitu mixing and cast as film by following the procedure in Example 7 and allowed to dry. The transparency of the film was measured to be 74%. The Shore A hardness was 60 and the percent water absorption for % hr soaking was found to be 52 wt %.

### Example 9

### Loading of Titania Nanoparticles

The product of Example 6 was loaded with 5 wt % high refractive index nanotitania particles by insitu mixing as described above and cast as film by following the procedure in Example 7 and allowed to dry. The film was slightly yellow in color.

### Example 10

### Loading of Ceria Nanoparticles

The product of Example 6 was loaded with 5 wt % high refractive index nanoceria particles by insitu mixing as described above, cast as film by following the procedure in example 7 and allowed to dry. The film was slightly yellow in color.

### Example 11

### Loading of Calcium

Samples of the film of Example 7a were dried and allowed to soak in aqueous saturated calcium chloride solution for 24 hours. Then the samples were washed in deionized water and allowed to dry. They were analyzed for the presence of calcium through SEM and EDX experiments.

### Example 12

### Loading of Aluminum

The film of example 7a was dried and allowed to soak in aqueous saturated aluminum sulfate solution for 24 hours. Then the samples were washed in deionized water and allowed to dry. This was analyzed for the presence of aluminum through SEM and EDX experiments.

### Example 13

### Loading of Silver into the Films

(a) The film of Example 7a was dried and allowed to soak in 0.1 M aqueous silver nitrate solution for half an hour in a brown glass bottle in a dark cabinet. Then the samples were allowed to dry and thereafter analyzed for the presence of silver through SEM and EDX experiments. The films turned to dark brown on exposure to air and heating. The EDX measurement shows the presence of 8% loading of silver in the sample, which is almost the replacement of the sodium from the elastomeric film.

(b) 0.1 wt % and 0.5 wt % of silver was loaded by mixing 0.0079 g and 0.039 g of silver nitrate each in 5 g of the sample of Example 4 and the procedure was followed as given in Example 7, cast as film and allowed to dry. The films were light brown to dark purple on exposure to air and heating.

TABLE 1

| | Youngs | Tensile | | | % Water absorption | |
|---|---|---|---|---|---|---|
| | modulus | strength | | Contact | (Water uptake at 37 C. | Hardness |
| Example | (MPa) | (MPa) | % Elongation | angle | for ½ hr immersion) | Shore—A |
| 7a | 2.1 | 1.58 | 37 | 67.6 | 50 | 48 |
| 7b | 1.2 | 1.12 | 150 | 90.0 | 38 | 32 |
| 9 | 5.0 | 0.68 | 100 | 83.2 | 36 | 18 |
| 10 | 1.1 | 0.94 | 130 | 80.1 | 22 | 32 |
| 11 | 3.6 | 0.7 | 130 | 67 | 14 | 48 |
| 12 | 6.1 | 0.4 | 5 | 70 | 9 | 48 |
| 13b | 9.5 | 0.57 | 5 | 67.9 | 44 | 45 |
| (0.1 wt % Ag) | | | | | | |

### Example 14

### Loading of Antibiotic

### Mupirocin

2.5 wt % of mupirocin was loaded into a film formed from the product of Example 3 by dissolving mupirocin in hot water (60° C.), combining the product of Example 3 into the aqueous mupirocin, and then depositing the solution onto a glass substrate to form a film thereon. A colorless transparent film was obtained with mupirocin loading.

### Example 15

### Loading of Vitamin C

### Ascorbic Acid

2.5 wt % of ascorbic acid was loaded to film formed from the product of Example 3 by dissolving ascorbic acid in water, combining the product of Example 3 into the aqueous ascorbic acid, and then depositing the solution onto a glass substrate to form a film thereon. A colorless transparent film was obtained with ascorbic acid loading.

### Example 16

### Controlled Release of Silver

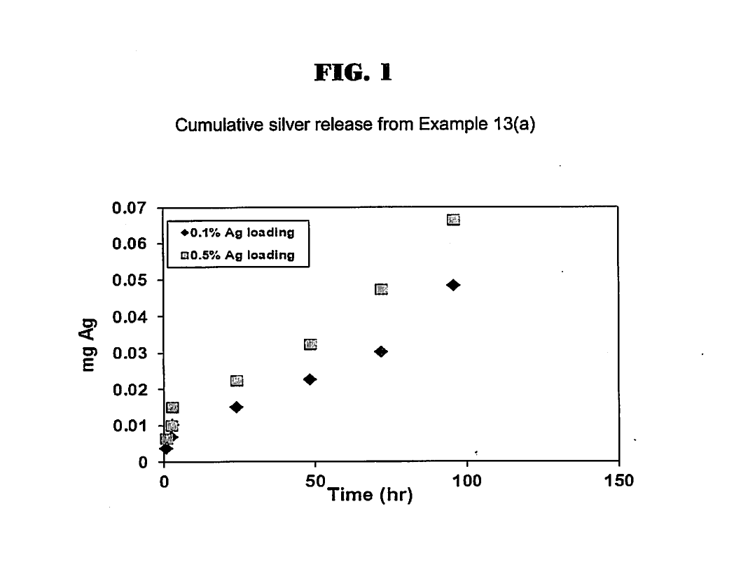

The silver loaded elastomeric films of Example 14b were dried and immersed in 50 mL of 0.01 M aqueous NaNO₃ solution at pH7. At regular intervals, 20 mL of the solution was withdrawn and replaced by NaNO₃ solution to study the cumulative release of silver by inductively coupled plasma analysis. This was done for over a period of 100 hrs. FIG. 1 shows the release of silver from the Example 14b with time and this follows a controlled release pattern with an initial burst of silver.

While the invention has been described with reference to a preferable embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims. All citations referred herein are expressly incorporated herein by reference.

What is claimed is:

1. An ionically cross-linked silicone elastomeric composition comprising
a) a polyorganosiloxane of the general formula
MₐM^{s}_{b}D_{c}D^{s}_{d}TₑT^{s}_{f}Q
wherein:
Mₐ=R¹R²R³SiO_{1/2}
M^{s}_{b}=R⁴R⁵R^{s}SiO_{1/2}
D_{c}=R⁶R⁷SiO_{2/2}
D^{s}_{d}=R⁸R^{s}SiO_{2/2}
Tₑ=R⁹SiO_{3/2}
T^{s}_{f}=R^{s}SiO_{3/2}
Q=SiO_{4/2}
and
R¹, R², R⁴, R⁵, R⁷, R⁸, are aliphatic, aromatic or fluoro containing monovalent hydrocarbon radicals containing from 1 to about 60 carbon atoms. This can be branched, linear or cyclic, saturated or unsaturated monovalent alkyl groups having from 1 to 36 carbon atoms, R³, R⁶, R⁹ can be independently chosen from glycolide {—C(O)CH₂O—}, lactide {—C(O)CH(CH₃)O—}, butyrolactide {—C(O)CH₂CH₂CH₂O—} and caprolactide {—C(O)CH₂CH₂CH₂CH₂CH₂O—} radicals or hydrocarbon radical defined by R¹,
Rₛ is (i) a monovalent radical bearing ion-pairs and having the formula -A-I^{x}Mₙ^{y+} wherein A is a spacing group having at least 1 spacing atoms selected from a divalent hydrocarbon or hydrocarbonoxy group, I is an ionic group, M is hydrogen or a cation independently selected from alkali metals, alkaline earth metals, transition metals, metal complexes and organic cations, hydrocarbon cations, alkyl cations, and cationic biopolymers n and y are integers independently of from 1 to about 6, and x is an integer which is the product of n times y, or Rₛ is (ii) zwitterions having the formula
—R′—NR″₂⁺—R′″-I where I is an ionic group such as sulfonate —SO₃⁻, sulfate —OSO₃²⁻, carboxylate —COO⁻, phosphonate —PO₃²⁻ and phosphate —OPO₃³⁻ group wherein R′ is a divalent hydrocarbon radical from 1 to 20 carbon atoms and R″ is divalent hydrocarbon radical from 2 to about 20 carbon atoms and R′″ is a divalent hydrocarbon radical from 2 to 20 carbon atoms; and,
b) optionally, a reinforcing or non-reinforcing filler.

2. The composition of claim 1, wherein the monovalent hydrocarbon radical is selected from the group consisting of methyl, ethyl, n-propyl, iso-propyl, n-butyl, isobutyl, tert-butyl, n-pentyl, iso-pentyl, neopentyl, tert-pentyl, hexyl, heptyl, octyl, nonyl decyl, cyclopentyl, cyclohexyl, cycloheptyl, methylcyclohexyl, phenyl, naphthyl; o-, m- and p-tolyl, xylyl, ethylphenyl and benzyl.

3. The composition of claim 1 wherein A is a divalent hydrocarbon group is aryl group selected from —(CH₂)_{g}C₆H₄—, —CH₂CH(CH₃)(CH₂)_{g}C₆H₄—, and —(CH₂)ₙC₆H₄(CH₂)_{g}— where h has a value of 1 to about 20 and g has a value of 0 to about 10.

4. The composition of claim 1 wherein A is a divalent hydrocarbon group is alkyne group selected from —(CHR¹⁰)ᵢ— where i has a value of 1 to 20 and R¹⁰ is hydrogen or R¹

5. The composition of claim 1 wherein A is a hydrocarbonoxy group selected from —CH(R¹⁰)ᵢ—O[CH(R¹⁰)(CH₂—O)]ᵢ—(CH₂)ⱼ—R¹⁰ is hydrogen or R¹ and i has a value of 1 to 20 specifically from 1 to about 10, j has a value of 0 to 50 and i′ has the value from 0 to 50.

6. The composition of claim 1, wherein R³, R⁶, R⁹ can be independently selected from —CH₂CH(R¹¹)(CₙH₂ₙ)—O—(C₂H₄O)ₒ—(C₃H₆O)ₚ—(C₄H₈O)_{q}—R¹¹, wherein n has a value in the range of 0 to about 6, subscripts o, p and q are independently selected from a value in the range of 0 to about 100, subject to the limitation of o+p+q greater than or equal to zero, R¹¹ can be hydrogen or an aliphatic, aromatic or fluoro hydrocarbon having from 1 to 60 carbon atoms, or R¹¹ can be independently chosen from glycolide, lactide, butyrolactide and caprolactide radicals, or R¹¹ can be independently chosen from acyl, epoxy and amine radicals.

7. The composition of claim 1 wherein the ionic group I is selected from sulfonate —SO₃⁻, sulfate —OSO₃²⁻, carboxylate —COO⁻, phosphonate —PO₃²⁻ and phosphate —OPO₃³⁻ groups.

8. The composition of claim 1 wherein the cation M is independently selected from but not limited to Li, Na, K, Cs, Mg, Ca, Ba, Zn, Cu, Ni, Fe, Ga, Al, Mn, Cr, Ag, Au, Pt, Pd, Pb, Sb, Sn, Ru, and Rh as well as their multivalent forms.

9. The composition of claim 1 wherein the cation M is a quaternary ammonium and phosphonium groups, hydrocarbon cations, alkyl cations and cationic biopolymers.

10. The composition of claim 1 including a filler of finely divided metal oxide with or without surface treatment.

11. The composition of claim 10 wherein the metal oxide is selected from silica, alumina, titania, zirconia, ceria and combinations thereof.

12. The composition of claim 1 including a filler selected from clay, boron nitride, carbon black, inorganic fillers, silicone resins, polysaccharides, natural and synthetic fibers and combinations thereof.

13. The composition of claim 1 including silver or aluminum.

14. A healthcare composition comprising the polyorganosiloxane of claim 1 including one or more additional agents selected from the group consisting of metals, metal ions, bioactives, anti-acne agents, anti-ageing agents, anti-caries agents, anti-fungal agents, anti-microbial agents, anti-oxidants, anti-cancer, anti-viral, anti-inflammatory, anti-coagulants, hemostatic agents, exfoliants, hormones, hormone analogs, enzymes, protein and peptides, medicinal compounds, biocides, external analgesics, oral care agents, oral care drugs, oxidizing agents, reducing agents, skin protectants, essential oils, insect repellents, UV light absorbing agents, solar filters, pigments, hydrating agents, vitamins and combinations thereof.

15. A healthcare composition of claim 14 comprising the polyorganosiloxane of claim 1, which can be used for applications comprising of drug delivery systems, transdermal patches, wound healing patches, wound dressing patches, transdermal iontophoresis, scaffold for tissue engineering, anti-microbial devices, wound management devices, ophthalmic devices, bioinserts, prostheses and body implants.

16. The composition of claim 15 wherein the antibiotic is mupirocin.

17. The composition of claim 14 wherein the vitamin is ascorbic acid and wherein the metals and metal ions are sodium, silver, aluminum, copper and calcium

18. A composition comprising the polyorganosiloxane of claim 1 and an agricultural agent, said agricultural agent being selected from a group comprising of fertilizers, micronutrients, insecticides, herbicides, rodenticides and miticides.

19. The composition of claim 18 wherein the composition is used as a coating for fertilizers.

20. The composition of claim 18 wherein the composition is used as a seed coating.

21. The composition of claim 18 wherein the composition is used as a super-spreader for the agricultural agent incorporated within.

22. A personal care composition comprising the polyorganosiloxane composition of claim 1, wherein personal care formulation comprises surfactants, emulsifiers, solvents, emollients, moisturizers, humectants, pigments, colorants, fragrances, biocides, preservatives, chelating agents, antioxidants, anti-microbial agents, anti-fungal agents, antiperspirant agents, exfoliants, hormones, hormone analogs, enzymes, protein and peptides, medicinal compounds, vitamins, alpha-hydroxy acids, beta-hydroxy acids, retinols, niacinamide, skin lightening agents, salts, electrolytes, alcohols, polyols, absorbing agents for ultraviolet radiation, botanical extracts, organic oils, waxes, thickening agents, particulate fillers, silicones, clays, plasticizers, occlusives, sensory enhancers, esters, resins, film formers, film forming emulsifiers, high refractive index materials and their combinations thereof.

23. A personal care composition of claim 22 comprising the silicone composition of claim 1, which can be used for personal care application comprising antiperspirant/deodorants, including sprays, sticks and roll-on products, shaving products, skin lotions, moisturizers, toners, bath products, cleansing products, shampoos, conditioners, combined shampoo/conditioners, mousses, styling gels, hair sprays, hair dyes, hair color products, hair bleaches, waving products, hair straighteners, nail polish, nail polish remover, nail creams and lotions, cuticle softeners, sunscreen, insect repellent, anti-aging products, lipsticks, foundations, face powders, eye liners, eye shadows, blushes, makeup, mascaras, moisturizing preparations, foundations, body and hand preparations, skin care preparations, face and neck preparations, tonics, dressings, hair grooming aids, aerosol fixatives, fragrance preparations, aftershaves, make-up preparations, soft focus applications, night and day skin care preparations, non-coloring hair preparations, tanning preparations, synthetic and non-synthetic soap bars, hand liquids, nose strips, non-woven applications for personal care, baby lotions, baby baths and shampoos, baby conditioners, shaving preparations, cucumber slices, skin pads, make-up removers, facial cleansing products, cold creams, sunscreen products, mousses, spritzes, paste masks and muds, face masks, colognes and toilet waters, hair cuticle coats, shower gels, face and body washes, personal care rinse-off products, gels, foam baths, scrubbing cleansers, astringents, nail conditioners, eye shadow sticks, powders for face or eye, lip balms, lip glosses, hair care pump sprays and other non-aerosol sprays, hair-frizz-control gels, hair leave-in conditioners, hair pomades, hair de-tangling products, hair fixatives, hair bleach products, skin lotions, pre-shaves and pre-electric shaves, anhydrous creams and lotions, oil/water, water/oil, multiple and macro and micro emulsions, water-resistant creams and lotions, anti-acne preparations, mouth-washes, massage oils, toothpastes, clear gels and sticks, ointment bases, topical wound-healing products, aerosol talcs, barrier sprays, vitamin and anti-aging preparations, herbal-extract preparations, bath salts, bath and body milks, hair styling aids, hair-, eye-, nail- and skin-soft solid applications, controlled-release personal care products, hair conditioning mists, skin care moisturizing mists, skin wipes, pore skin wipes, pore cleaners, blemish reducers, skin exfoliators, skin desquamation enhancers, skin towelettes and cloths, depilatory preparations, personal care lubricants, nail coloring preparations, sunscreens, cosmetics, hair care products, skin care products, toothpastes, drug delivery systems for topical application of medicinal compositions that are to be applied to the skin and combinations comprises at least one of the foregoing applications.

24. An anti-fouling composition comprising the organosiloxane of claim 1.

25. The anti-fouling composition of claim 24 wherein the anti-fouling agent comprises of cationic antifoulants, metal ions, metal-organic complexes, 4,5-dichloro-2-octyl-2H-isothiazole-3-on, benzalkonium chloride, or Zineb.

26. The anti-fouling composition of claim 24 wherein the composition is used as paints, structural coatings, masonry coatings, and marine coatings.

27. An application in the area of oil and gas comprising the use of compositions containing 0.01-100% of the organosiloxane of claim 1.

28. An application in the area of upstream, midstream and downstream operations of hydrocarbon resources comprising the use of compositions containing 0.01-100% of the organosiloxane according to claim 1.

29. An application comprising the organosiloxane of claim 1

30. The application of claim 29 wherein the application is further chosen from selected from the group consisting of automotive, household, paints, coatings, laundry detergent, textile treatment, fuel cell, electronic applications, agriculture, membranes, adhesives, sealants, injection moldable and compression moldable rubbers and plastics, and various silicone based rubbers.
